(19) United States
(12) Patent Application Publication
(10) Pub. No.: US 2008/0275812 A1
(43) Pub. Date: Nov. 6, 2008

(54) CREDIT UNDERWRITING FOR MULTIPLE FINANCIAL TRANSACTIONS

(76) Inventor: Brian Stone, Norcross, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/172,567

(22) Filed: Jul. 14, 2008

Related U.S. Application Data
(63) Continuation of application No. 11/160,127, filed on Jun. 9, 2005.

(51) Int. Cl. G06Q 20/00; G06Q 40/00

(52) U.S. Cl. 705/38; 705/40

(57) ABSTRACT

Credit underwriting of bill payments, or other financial transactions on a transaction by transaction basis. A customer is enabled to request the approval of a loan for the payment of a particular financial transaction. The customer provides sufficient information to identify the account and transaction amount. A front end engine performs an approval process and if the customer is approved, provides the terms and conditions of the loan for the payment of the financial transaction. If the customer accepts the terms and conditions, the funds for payment of the transaction are presented to a merchant for payment. The customer is then required to repay the loan after a particular period of time, along with any fees.

### CROSS-REFERENCE TO RELATED APPLICATIONS

This application is related to U.S. patent application Ser. No. 10/645,949 filed on Aug. 22, 2003 and U.S. patent application Ser. No. 10/706,470 filed on Nov. 12, 2003, both of which are hereby incorporated by reference and is related to United States patent application having a title of CREDIT UNDERWRITING BASED ON PAPER INSTRUMENT, assigned Ser. No. ______ filed on ______ and United States patent application having a title of CREDIT UNDERWRITING BASED ON ELECTRONIC FUND TRANSFER, assigned Ser. No. ______ filed on ______.

### BACKGROUND OF THE INVENTION

The name of the game in the electronic age is convenience. The one thing that is quite evident is that the convenience lags somewhat behind technological developments. For instance, the Internet, or its predecessor DARPA, was around for many years before the widespread deployment of web surfing, web browsers and web applications. However, as technology is adopted, and then applied to particular tasks, eventually the convenience of the technology is realized.

Another hurdle that oftentimes retards the application of technology to make everyday tasks more convenience is fear. Sometimes this fear is unfounded and is simply paranoia. However, other times the fear is quite legitimate. For instance, the fear of identify theft or electronic funds theft is a quite well-founded fear. In fact, many companies that focus entirely on the issues of improving such security have grossed billions of dollars in revenue.

One recent advancement that is gaining significant popularity is online bill payment. Using this technology, not only do customers save significant time in paying monthly bills, but the entire financial industry also greatly benefits due to, among other things, reduced processing cost by eliminating or reducing the handling of paper checks.

Companies such as CompuCredit have developed financial products that are focused on providing convenience to financial services customers. Some of the CompuCredit products include: (a) a checkless checking account as described in U.S. patent application Ser. No. 10/645,949 filed on Aug. 22, 2003; and (b) a credit account to assist in debt recovery as described in U.S. patent application Ser. No. 10/706,470 filed on Nov. 12, 2003.

A need that exists in the art is the ability for an individual to obtain a loan in an expedited manner to help the individual pay his or her bills on time. For those individuals that do not meet the traditional qualifications for obtaining credit, there is a need in the art for the ability to obtain such a loan based on other qualifying elements. One such qualifying element can be the expected reception of a paycheck or other anticipated income, and/or the granting of access to those funds as collateral for the loan. Ideally, such a product would allow an individual to receive funds for the payment of bills or the satisfaction of other financial obligations just prior to actually having received his or her funds. Once the individual receives the funds, the loan can be paid off using those funds. Thus, the loan is underwritten based on the expected reception of future funding. For a credit underwriting that is based on an anticipated paycheck, the loan can be coined as a payday loan. There is a need in the market for such a product to allow a consumer to access a loan using a pending paycheck or the reception of other funds as collateral.

It will be appreciated that such a solution would require some level of assurance on the part of the financial institute that the funds for the repayment of the loan will be available and to gain some amount of leverage on the consumer to encourage the credit underwriting. Thus, there is a need in the art for a credit underwriting product that not only grants a loan to a consumer based on expected income or funding but also provides a level of assurance that the loan can be collected against the collateral.

There is also a need in the art for a method to provide loans for the payment of specific bills or debts and to have the approval of credit underwriting for such loans to be tied to the satisfaction of particular debts.

### BRIEF SUMMARY OF THE INVENTION

The present invention is directed towards the approval and operation of bill payment loans. More specifically, the present invention is directed towards the issuance of individual loans that are tied to specific bills or debts that require payment. For each such bill or debt, the customer is submitted to a separate approval process and a separate loan to coTer the bill or debt is issued.

the provision of credit underwriting for such loans can be based on a variety of factors, including, but not limited to those disclosed in United States patent application having a title of CREDIT UNDERWRITING BASED ON PAPER INSTRUMENT, assigned Ser. No. ______ filed on and United States patent application having a title of CREDIT UNDERWRITING BASED ON ELECTRONIC FUND TRANSFER, assigned Ser. No. ______ filed on ______.

In one embodiment of the present invention, the credit underwriter or lending institute may partner with a bill payment or online bill payment company. Such companies can include traditional banks providing online services, or more particular companies such as PayPal. Such a partnership advantageously facilitates the transfer of funds toward the satisfaction of particular bills or debts.

In an embodiment of the invention, a consumer establishes a master bill payment account with the lending institute, a traditional bank, or a bill payment specific company. The master bill payment account may be structured to include multiple sub-accounts, with each sub-account being associated with a particular bill payment and merchant. When the customer signs up for the bill payment loan service, the various account numbers and billing information for each sub-account and the master account are collected. Once approved, the consumer may be granted a loan, a line of credit or some other form of credit approval that can be applied for the fulfillment of bill payments.

The present invention may be embodied into an online or telephonic based bill payment system. A customer, once initialized, simply invokes the system through a computer terminal or a telephone apparatus. The customer gains authorized access to the system and then requests the payment of a particular bill. The request may include an account identifier, a merchant identifier and/or a bill amount. The system initiates a process to approve the customer for a loan to pay the identified bill. If the loan is approved, the funds necessary to satisfy the bill are either transferred into the customer's account for payment or are transmitted directly to the merchant. Subsequently, the customer is requested to pay off the loan, along with any interest and fees.

Thus, the various embodiments of the present invention enable a customer to obtain a credit underwriting approval for a loan against the expected reception of future funds, and then to have the loan paid off automatically once the customer receives the funds.

### BRIEF DESCRIPTION OF THE SEVERAL VIEWS OF THE DRAWING

FIG. 1 is a block diagram illustrating the various components and operations involved in an exemplary embodiment of the present invention.

FIG. 2 is a flowchart diagram illustrating the steps involved in an embodiment of the present invention.

### DETAILED DESCRIPTION OF THE INVENTION

The present invention is directed toward a credit underwriting of a loan that can give a consumer rapid access to funds using the future payment of expected funds as collateral and, provides a mechanism for the lending institute to have a level of assurance that the loan payoff can be collected. More specifically, aspects of the present invention can include (1) the approval of a consumer for a loan (2) basing the approval of the loan, at least in part, on the use of the consumer's future paycheck(s) or other expected funds as collateral for the loan (3) establishing a level of assurance that the financial or lending institute will be able to recoup the investment; and (4) the application of the loan for the payment of multiple financial transactions.

Advantageously, various embodiments of the present invention enable a consumer to gain access to funds through a loan instrument based on an expected reception of near-term funds, such as a paycheck. Such a loan can be used for a variety of purposes including the payment of bills that have come due prior to the reception of the consumer's paycheck, making a down payment on a house, making a mortgage payment, purchasing a product or service, facilitating the collection process for a credit card or any of a variety of other financial products. The loan or the credit underwriting can also be provided as an overdraft credit plan or extended to maintain a specified minimum balance in the consumer's account.

The loan can be granted in a variety of manners. Non-limiting examples include through the use of a credit card, a debit card or a direct issue of funds into the consumer's account.

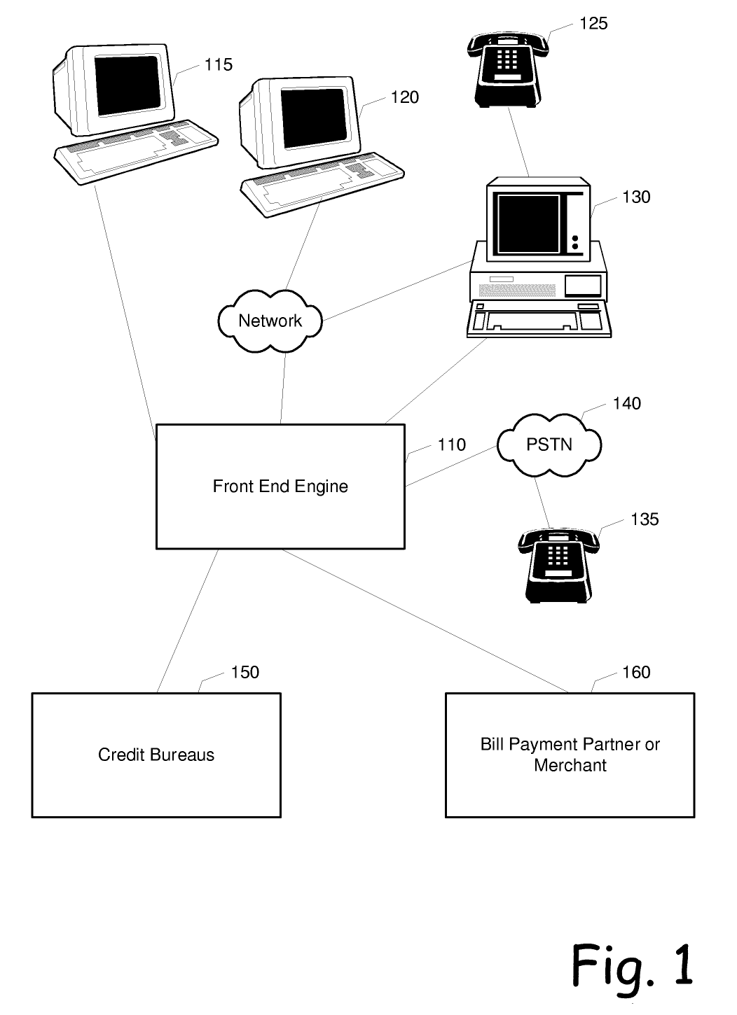

FIG. 1 is a block diagram illustrating the various components and operations involved in an exemplary embodiment of the present invention. A front end engine 110 provides the main functionality. The front end engine interfaces to the customers through various access techniques such as a directly connected computer 115, an Internet connected computer 120 running either a program or a web browser that invokes an application on the front end engine 110, a telephone 125 connected to a computer 130 housing an IVR or VRS function or that interfaces the telephone to an IVR or VRS function in the front end engine, a telephone 135 connected to the front end engine 110 through the PSTN 140, or other interface techniques.

IVR is short for interactive voice response, which is a telephony technology in which someone uses a touch-tone telephone to interact with a database to acquire information from or enter data into the database. IVR technology does not require human interaction over the telephone as the user's interaction with the database is predetermined by what the IVR system will allow the user to perform. For example, banks and credit card companies use IVR systems so that their customers can receive up-to-date account information instantly and easily without having to speak directly to a person. VRS is short for voice recognition system, which is a telephone technology similar to IVR except that the spoken words of the customer are translated into commands or data on which to be operated.

In one embodiment, the computer 120 is connected to the front end engine 110 over an IP network. In such an embodiment, the computer 120 runs a browser that is used to interface to a web-based application running on the front end engine 110. The web application can render a customer interface through the browser running on the computer 120 for requesting information, providing status, and receiving information from the customer. In another embodiment, the computer 120 may operate as a dumb terminal simply accessing an application running on the front end engine 110. In yet another embodiment, the computer 120 may include an application that interfaces with another application running on the front end system 110 and the two applications share functionality.

The front end engine 110 may also include an interface to one or more credit bureaus or external credit sources 150, such as but not limited to, Teletrack, ChoicePoint, Equifax, Experion, etc. The front end engine 110 also interfaces to a bill payment partner or directly to one or more merchant systems 160.

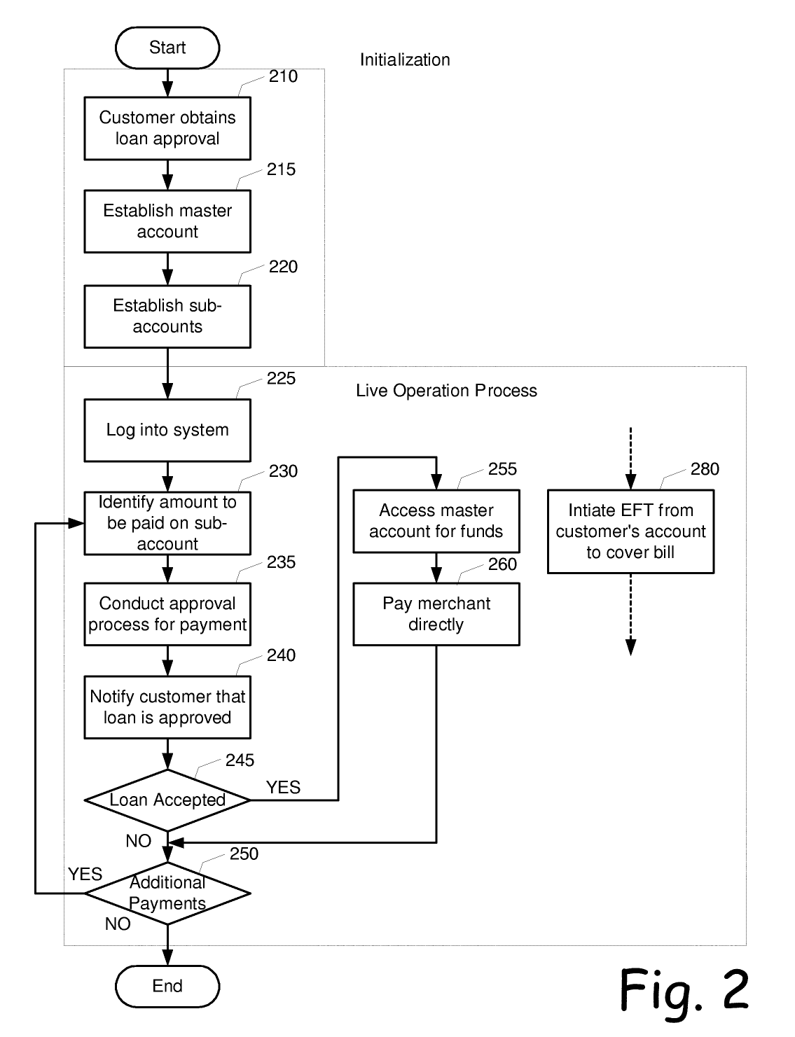

FIG. 2 is a flowchart diagram illustrating the steps involved in an embodiment of the present invention. By referring to FIG. 1 as we describe the steps of FIG. 2, the operation of one embodiment of the present invention can be more fully understood. The operation will be described as including two process, the initialization process and the live operation process.

At step 210 the initialization process begins with the customer applying for and obtaining approval for a general loan. The general loan could by a short-term loan, long-term loan or credit underwriting similar to those found in United States patent application having a title of CREDIT UNDERWRITING BASED ON PAPER INSTRUMENT, assigned Ser. No. ______ filed on ______ and United States patent application having a title of CREDIT UNDERWRITING BASED ON ELECTRONIC FUND TRANSFER, assigned Ser. No. ______ filed on ______, or may be some other loan instrument. The general loan may be full approval of the entire amount the customer will need to pay bills or conduct various financial transactions, or it may simply be a preliminary approval of an expected amount that must be subjected to more specific approval prior to being issued.

In one embodiment, a general or master account is established for receiving funds for the customer 215. At step 220, sub-accounts are established. This step may involve the customer providing information such as, account numbers, merchants, merchant contact information, or the like. In one embodiment, a sub-account is established for each potential bill/merchant that needs to be paid by the customer. Upon completing step 220, the initialization process is completed.

The live operation process begins at step 225 with a customer logging into an account to perform online bill payment. In one embodiment of the invention, the customer logs into an online bill payment, or other financial transaction payment system 160 that in turn can access the operations of the front end engine 110. In another embodiment, as illustrated in FIG. 1, the customer logs into the front end system 110 to gain access to the master account. The customer can log in through a variety of techniques as illustrated in FIG. 1. Once the customer logs into the master account, the customer identifies a particular sub-account by identifying the account number or the merchant, and then identifies an amount to be paid.

The front end engine 110, upon receiving a sub-account number or merchant identifier, and an amount to pay, conducts an approval process 235. The approval process can include a variety of steps, including but not limited to querying a credit bureau to obtain credit information on the customer, securing a likelihood of payback based on future expected funds, or other steps. However, the approval process is conducted for each individual bill and merchant.

Once a loan for a particular bill payment is approved, the customer is notified that the loan has been approved 240. The notification may also include the identification of the fee associated with the loan, the payback date of the loan, as well as other terms and conditions for the loan. The customer may then be provided the opportunity to accept or reject the terms of the loan.

If the customer accepts the terms of the loan, the front end engine 110 accesses a master account for the customer and withdraws the funds necessary to satisfy the payment 255. The front end system 110 then directly pays the merchant in satisfaction of the bill 260. Upon completion, if there are additional bills to be paid 250, processing returns to step 230 to identify the next bill to be paid. Otherwise processing stops.

Periodically or a periodically, the customer's account is reconciled. This can be done in a variety of manners; however, the illustrated manner includes setting up an electronic fund transfer from the customer's account 280 at the end of a particular period to access funds to not only satisfy the loan, but also any fees or interest associated with the loan.

Thus, it has been shown that the present invention provides a method for the payment of bills. A goal of the invention is to allow individuals or entities to have funds for the payment of bills or other financial transactions in the form of a general loan. As the individual pays bills or conducts financial transactions, the individual is approved for the loan on a transaction by transaction basis. For instance, it the customer utilizes the loan for the payment of bills, the approval is performed on a bill by bill basis. The funds to pay the bill are extracted from an account set up for the individual by a credit company or a lending institute, or are paid directly by the lending institute to the merchant. After a period of time, a financial account of the individual is accessed to obtain payment of the loan, along with any applicable fees.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of skilled in the art. The scope of the invention is limited only by the following claims.

1.-13. (canceled)

14. A system for providing a bill payment loan service, the system comprising:
a front end engine for interfacing with a lender, a plurality of merchants, and a customer; and
an application executed by the front end engine for enabling the customer to apply for a bill payment loan, facilitating the approval of the bill payment loan by the lender, and enabling the customer to pay bills associated with the plurality of merchants using funds from the bill payment loan, the application comprising functionality for performing the following steps:
approving the customer for the bill payment loan based at least in part on anticipated income;
establishing a funded master account associated with the lender for receiving the funds from the bill payment loan, the funded master account being linked to a financial account of the customer;
providing the lender with access to the financial account;
establishing a plurality of pay sub-accounts associated with the funded master account, each pay sub-account corresponding to one of the plurality of merchants and having a unique account identifier;
receiving a request from the customer to pay a bill from one of the plurality of merchants, the request including a pay amount and information for identifying the unique account identifier corresponding to the pay sub-account associated with the merchant;
paying the bill from the pay sub-account associated with the merchant; and
at least partially satisfying the bill payment loan against the customer's financial account.

15. The system of claim 14, wherein the functionality comprising the application interfaces with the customer via an interactive voice response system.

16. The system of claim 14, wherein the functionality comprising the application interfaces with the customer via a web application.

17. The system of claim 14, wherein one of the merchants comprises a bill payment partner.

18. The system of claim 14, wherein the step of paying the bill from the pay sub-account associated with the merchant comprises electronically paying the merchant.

19. The system of claim 14, wherein the step of paying the bill from the pay sub-account associated with the merchant comprises enabling the merchant to access the pay sub-account and withdrawal the pay amount.

20. The system of claim 14, wherein the step of at least partially satisfying the bill payment loan against the customer's financial account comprises initiating an electronic funds transfer from the customer's financial account.

21. A method for providing a bill payment loan service to a lender, a plurality of merchants, and a customer, the method comprising
approving a customer for a bill payment loan based at least in part on anticipated income;
establishing a funded master account associated with a lender for receiving funds from the bill payment loan, the funded master account being linked to a financial account of the customer for providing the lender with access to the financial account;
establishing a plurality of pay sub-accounts associated with the funded master account, each pay sub-account corresponding to one of a plurality of merchants and having a unique account identifier;
receiving a bill pay request from the customer to pay a bill from one of the plurality of merchants, the request including a pay amount and information for identifying the unique account identifier corresponding to the pay sub-account associated with the merchant;
paying the bill from the pay sub-account associated with the merchant; and
at least partially satisfying the bill payment loan against the customer's financial account.

22. The method of claim 21, wherein the approving the customer for the bill payment loan comprises: receiving a bill payment loan request from the customer.

23. The method of claim 21, wherein the bill payment loan request and the bill pay request are received via an interactive voice response system.

24. The method of claim 21, wherein at least one of the bill payment loan request and the bill pay request is received via at least one of an interactive voice response system and a web application.

25. The method of claim 21, wherein at least one of the merchants comprises a bill payment partner.

26. The method of claim 21, wherein the bill is paid directly to the merchant.

27. The method of claim 21, wherein the paying the bill from the pay sub-account comprises providing the merchant with electronic access to the pay sub-account.

28. The method of claim 21, wherein the step of at least partially satisfying the bill payment loan against the customer's financial account involves an electronic funds transfer from the customer's financial account.
